(19) United States
(12) Patent Application Publication
(10) Pub. No.: US 2023/0132956 A1
(43) Pub. Date: May 4, 2023

(54) Transport System

(71) Applicant: Robert Bosch GmbH, Stuttgart (DE)

(72) Inventor: Martin Reinisch, Esslingen (DE)

(21) Appl. No.: 17/915,414

(22) PCT Filed: Mar. 15, 2021
(86) PCT No.: PCT/EP2021/056472

§ 371 Date: Sep. 28, 2022

(30) Foreign Application Priority Data
Apr. 21, 2020 (DE) 10 2020 205 002.3

(51) Int. Cl. B65G 43/00

(52) U.S. Cl. CPC B65G 43/00

(57) ABSTRACT

The disclosure relates to a transport system including two flat transport devices which are arranged perpendicularly to each other. Each transport device has a stator, along the plane of which at least one carrier can be moved. At least one support is provided for receiving a payload. The support can be brought into form-fitting engagement with the horizontal carrier via a first engagement means and into form-fitting engagement with the vertical carrier via a second engagement means. The two form-fitting engagements are designed such that the support is supported against each carrier against the force of gravity and is prevented from horizontally moving or rotating, and the support is transferred between the two transport devices only by means of the aforementioned movement functions of the two pertinent carriers.

SPECIFICATION

The invention relates to a magnetic transport system composed of a horizontal transport installation and of a vertical transport installation, according to the preamble of patent claim 1.

Disclosed in publication DE 10 2016 224 951 A1 is a planar drive, or a transport installation, respectively, the carriers of which are moved by means of magnetic force along a plane formed by a stator. The carriers here can be held and moved so as to float above the plane. Controlled movements in up to six degrees of freedom are possible. The carrier carries a load which in this document is referred to as a payload. The transport installation can be installed and utilized in a tabletop operation, thus horizontally, or alternatively in a wall-mounted operation, thus vertically.

Publication DE 10 2016 205 513 A1 discloses a transport system which is configured as a combination of a horizontal transport installation and a vertical transport installation. Both transport installations function magnetically and in a non-contacting manner. Here, a carrier is attached so as to be horizontally movable on the horizontal transport installation, a payload referred to as an item of goods being fastened to said carrier. Separately therefrom, a carrier is attached so as to be vertically movable on the vertical transport installation, a separate payload being fastened to this carrier.

In such transport systems it is disadvantageous that a payload may not be transferred from the horizontal transport installation to the vertical transport installation and vice versa, or may be transferred only by way of a special, separate handing system.

Accordingly, the invention is based on the object of achieving a transport system in which the payload is movable continuously between a horizontal transport installation and a vertical transport installation.

This object is achieved by a transport system having the features of patent claim 1.

Further advantageous design embodiments of the invention are described in the dependent patent claims.

The transport system according to the invention has a horizontal transport installation having a horizontal stator by means of which at least one horizontal carrier is movable in a horizontal plane, in particular along an X-axis and along a Y-axis, relative to the horizontal stator. Furthermore, the transport system according to the invention has a vertical transport installation having a vertical stator by means of which at least one vertical carrier is movable in a vertical plane, in particular along the Y-axis and along a Z-axis, relative to the vertical stator. Provided here is at least one mounting for receiving a payload. According to the invention, the mounting has first engagement means and separate second engagement means, wherein the mounting by way of the first engagement means thereof is able to be brought to engage in a form-fitting manner with the horizontal carrier, and wherein the mounting by way of the second engagement means thereof is able to be brought to engage in a form-fitting manner with the vertical carrier. The two form-fitting engagements are designed such that the mounting is supported on the respective carrier in relation to gravity, and is secured in relation to horizontal displacement and rotation.

According to the invention, this is a purely passive solution which is simple in terms of devices and thus cost-effective, in which a transfer of the mounting between the two transport installation takes place purely by the above-mentioned motion functions of the two affected carriers. In this way, no further activation (of the mounting or of the two carriers), and in particular no special separate handing system, is required.

In a particularly preferred application of the transport system, the payload is a workpiece so that the mounting is a workpiece mounting.

In a variant of the above-mentioned design embodiment according to the invention, the mounting can also be replaced by the payload so that the payload per se has the first and the second engagement means. The carrier can thus be dispensed with.

The horizontal carrier, by means of the horizontal stator, to a limited extent is preferably also movable relative to the horizontal stator perpendicularly to the horizontal stator, in particular along the Z-axis. In this way, the horizontal carrier can be moved so as to float above the horizontal plane of the horizontal stator and be displaced parallel to the horizontal plane in a non-contacting manner. The same applies in an analogous manner also to the vertical transport installation. The vertical carrier, by means of the vertical stator, to a limited extent is thus preferably also movable relative to the horizontal stator perpendicularly to the vertical stator, in particular along the X-axis. In this way, the vertical carrier can be moved so as to be spaced apart from the vertical plane of the vertical stator and be displaced parallel to the vertical plane in a non-contacting manner.

The first engagement means can be magnetic. In this way, the mounting is secured in relation to the horizontal displacement and rotation relative to horizontal carriers.

It is particularly preferable for the first engagement means to be at least two downward-directed perpendicular appendages (e.g. studs or pins) which are disposed on a lower side of the mounting, and for the horizontal carrier on the upper side thereof to have a corresponding number of clearances (e.g. bores) that are open toward the top. Conversely, the first engagement means can, of course, also be at least two clearances which are disposed on a lower side of the mounting and are open toward the bottom, when the horizontal carrier on the upper side thereof has a corresponding number of upward-directed perpendicular appendages. In both variants, the mounting is secured in relation to the horizontal displacement and rotation relative to the horizontal carrier by way of a form-fit.

In order to enable herein a pattern of half a revolution about a vertical axis of the mounting, correspondingly having two defined bearing positions of the mounting on the horizontal carrier, it is preferable for the at least two pairs of appendages and clearances to be provided or mutually diagonally opposite corner regions of the mounting and of the horizontal carrier.

In order to enable herein a pattern of a quarter revolution about the vertical axis of the mounting, correspondingly having four defined bearing positions of the mounting on the horizontal carrier, it is preferable for two further pairs of appendages and clearances to be provided, so that one pair of appendages and clearances are in each case provided in all four corner regions of the mounting and of the horizontal carrier. More than four pairs of appendages and clearances may also be provided.

A certain tolerance in terms of the position in the horizontal plane, in particular along the X-axis and the Y-axis, and self-centering of the mounting on the horizontal carrier when transferring the mounting from the vertical carrier to the horizontal carrier are possible when the clearances and the appendages are conical or coniform or frustoconical, or have the shape of a spherical segment. In this way, the mounting is precisely positioned after being transferred from the vertical carrier to the horizontal carrier, and a precise detection of the position of the horizontal carrier by means of a sensor system means a precise detection of the position of the payload, in particular of the workpiece, for example for further machining of the latter.

The vertical carrier preferably has two webs, or a fork with two prongs. In this instance, the mounting has two mutually opposite lateral peripheries on which the second engagement means are at least partially disposed or formed. The second engagement means are able to be at least partially supported on the two webs or prongs of the vertical carrier.

A spacing of the two lateral peripheries of the mounting, in particular along the Y-axis, corresponds to approximately the spacing of the two webs or prongs (including a variance of at most 10%, for example).

The two planes of the stators intersect in an abutting edge which extends in particular along the Y-axis and of which the length corresponds to at least the spacing of the webs or prongs, respectively, and/or at least the spacing of the two lateral peripheries of the mounting. A transfer point of the mounting between the two affected carriers is defined in this way. The abutting edge may also be longer. In this way, various transfer points can be implemented along the abutting edge.

In order to enable herein a pattern of half a revolution about the vertical axis of the mounting by way of two correspondingly defined bearing positions of the mounting on the vertical carrier, it is preferable for the two webs or prongs, respectively, to be approximately mutually parallel and approximately level, and wherein the two lateral peripheries are approximately mutually parallel and approximately level. In this way, the two webs or prongs, respectively, and the two lateral peripheries are approximately parallel to the horizontal plane. The two webs or prongs, respectively, extend away from the vertical carrier, in particular along the X-axis.

In order to enable herein a pattern of a quarter revolution about the vertical axis of the mounting by way of four correspondingly defined bearing positions of the mounting on the vertical carrier, it is preferable for the mounting to have two further mutually opposite, approximately parallel and approximately level lateral peripheries on which further engagement means from the group of second engagement means are disposed or formed. Said further engagement means, as an alternative to the first-mentioned engagement means from the group of second engagement means, can be supported on the webs or prongs of the vertical carrier when the mounting is to be supported in relation to gravity by the vertical carrier, said mounting being in a position rotated by 90 degrees about the vertical axis.

In this instance, the spacing of the two further lateral peripheries of the mounting, in particular along the Y-axis, also corresponds to approximately the spacing of the two webs or prongs, respectively (including a variance of at most 10%, for example). In this way, access to the mounting or to the payload is possible from all sides during the operation of the vertical transport installation, i.e. also from below by reaching between the two webs or prongs, respectively.

According to a first exemplary embodiment of the second engagement means, the mounting on the two or four lateral peripheries has in each case two roof-shaped or arcuate receptacle portions. Each web, or each prong, respectively, here correspondingly has two U-shaped or V-shaped receptacle portions or notches in which the roof-shaped or arcuate receptacle portions can be received. In this way, the carrier is secured in relation to the horizontal displacement and rotation relative to vertical carriers by way of a form-fit.

The four or eight roof-shaped or arcuate receptacle portions can be formed on hooks protruding laterally from a main body of the mounting. Here, the spacing of the two or four lateral peripheries of the mounting in pairs is somewhat smaller than the spacing of the webs or prongs.

More than eight hooks may also be provided on the mounting.

According to a second exemplary embodiment of the second engagement means, the latter are formed by level grooves or steps which are in each case disposed below the two or the four lateral peripheries of the mounting. In this instance, one web, or one prong, respectively, is in each case at least in portions receivable in the grooves; or one web, or one prong, respectively, is in each case at least in portions able to be brought to bear on the steps. The spacing of the two or four lateral peripheries of the mounting in pairs here is somewhat larger than the spacing of the webs or prongs.

In order to have as many identical parts as possible in the transport system according to the invention, in particular when a plurality of carriers are used, it is preferable for a main body of the at least one horizontal carrier and a main body of the at least one vertical carrier to be of identical construction. In particular, the main body can correspond to the horizontal carrier, and the vertical carrier in this instance is produced merely by fastening the two webs, or the fork, respectively, to a main body of this type.

In order to facilitate the pattern of a quarter revolution about the vertical axis of the mounting by way of four correspondingly defined bearing positions of the mounting on the horizontal carrier, on the one hand, and on the vertical carrier, on the other hand, it is preferable for the main body of the horizontal carrier and the main body of the vertical carrier and the main body of the mounting to have in each case a square base area.

The horizontal stator is preferably formed in a modular manner from horizontal stator tiles, and the vertical stator is formed in a modular manner from vertical stator tiles. The stator tiles generate a travelling magnetic field which can be effective beyond peripheries of the stator tiles, wherein the carriers each have at least one permanent magnet by means of which the carrier is movable. In order to have as many identical parts as possible in the transport system according to the invention, it is preferable for the horizontal stator tiles and the vertical stator tiles to be identical.

In order to be able to approach in a reliable and reproducible manner the at least one transfer point to the horizontal carrier, on the one hand, and to the vertical carrier, on the other hand, it is particularly preferable for the respective sensor system, by way of which the position of the respective carrier relative to the respective stator is able to be determined, to be disposed on the horizontal and the vertical stator. A sensor system of this type is often also required for positioning the carrier, and thus the mounting having the payload thereof, at a machining station of the respective transport installation.

A plurality of exemplary embodiments of the transport system according to the invention are illustrated in the figures in which:

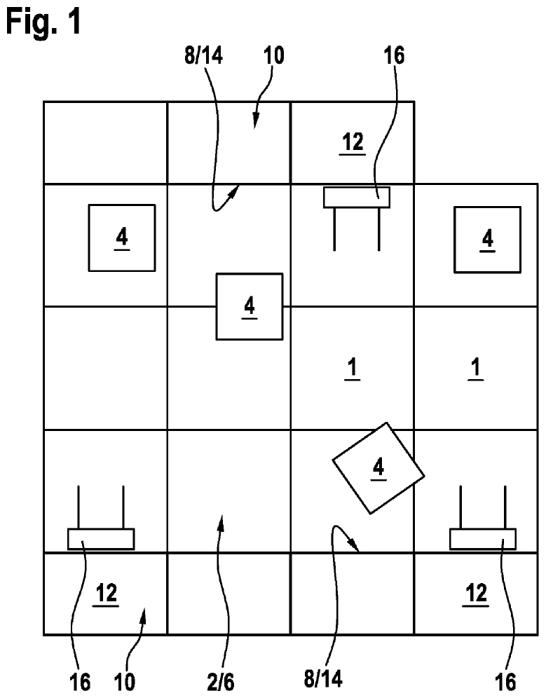

FIG. 1 shows an exemplary potential construction of the transport system according to the invention in a plan view;

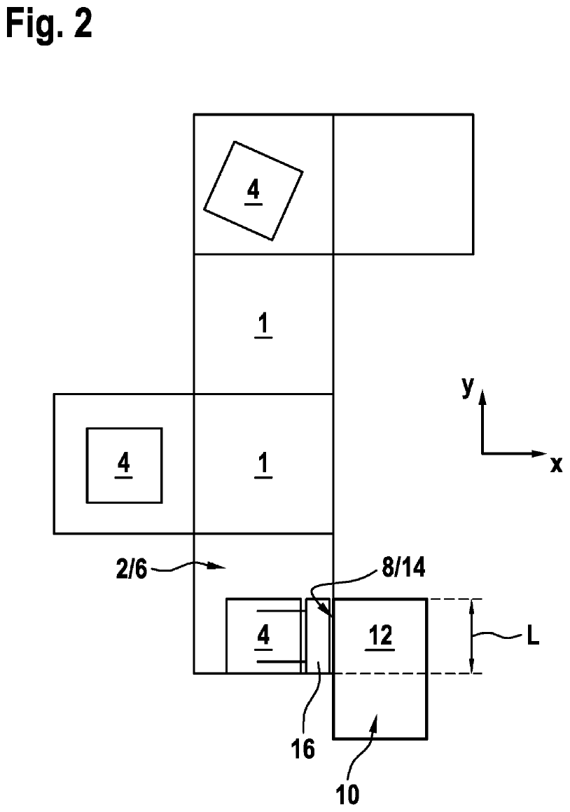

FIG. 2 shows a further exemplary potential construction of the transport system according to the invention in a plan view;

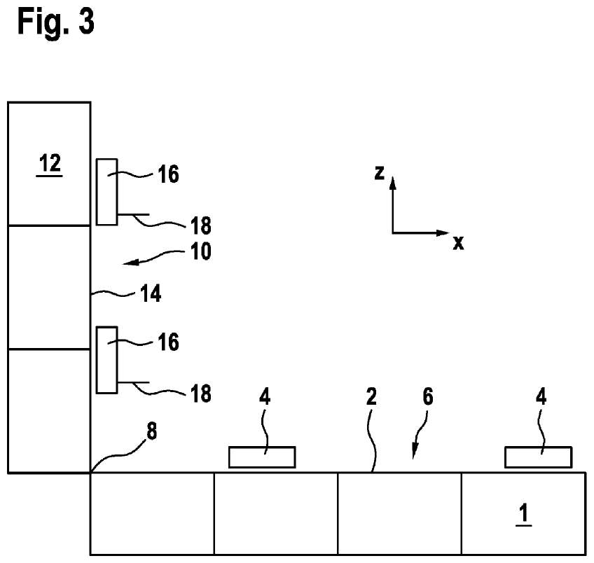

FIG. 3 shows a further exemplary potential construction of the transport system according to the invention in a lateral view;

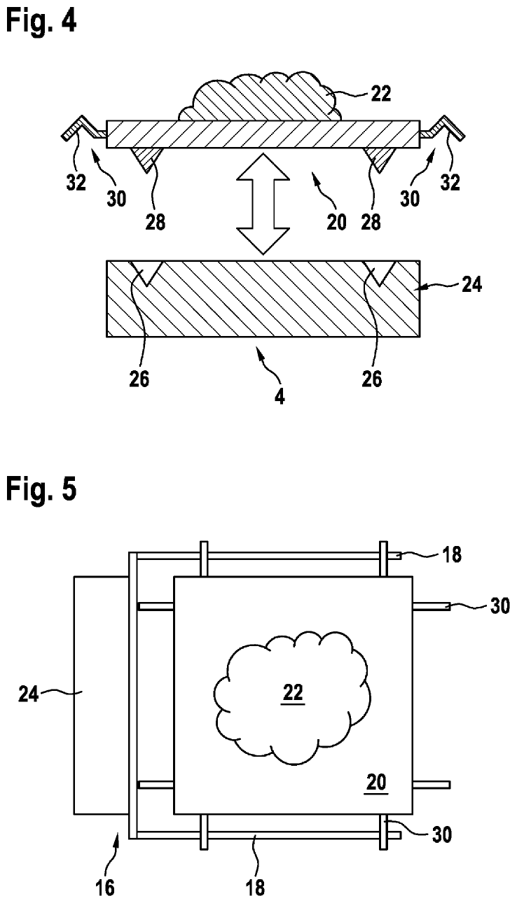

FIG. 4 shows a sectional illustration of a lateral view of a mounting having a payload, and of a horizontal carrier, said mounting and carrier being able to be utilized in one of the three preceding examples of transport systems;

FIG. 5 shows a plan view from above onto the mounting having a payload from FIG. 4, and onto a vertical carrier;

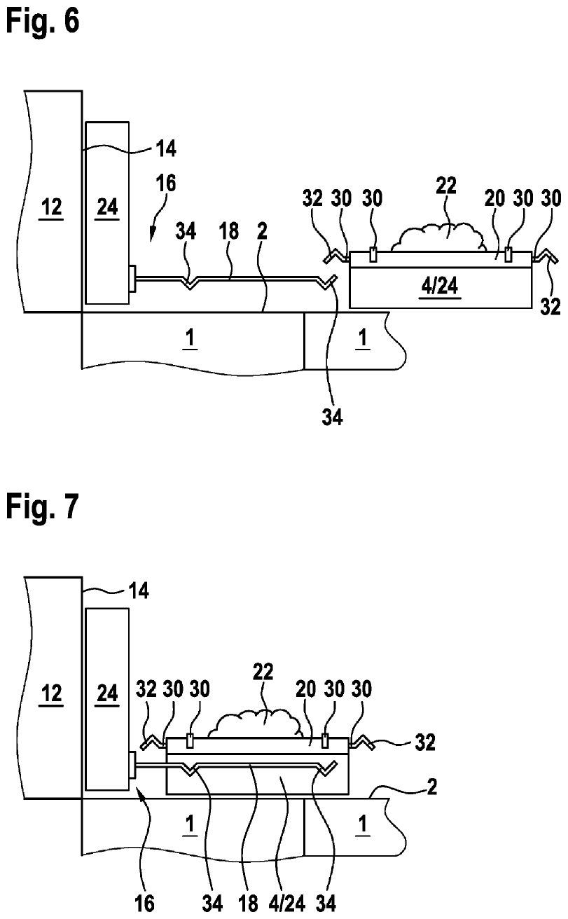

FIG. 6 shows a first step of a transfer of the mounting from the horizontal carrier to the vertical carrier in a lateral view, wherein the figure also shows a third step of a transfer from the vertical carrier to the horizontal carrier;

FIG. 7 shows an intermediate step of the transfer of the mounting between the two carriers in a lateral view;

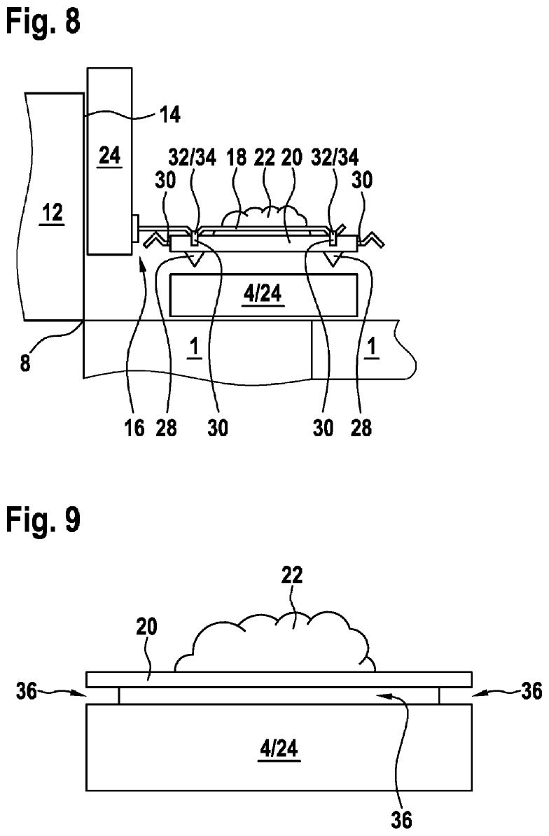

FIG. 8 shows a third step of the transfer of the mounting from the horizontal carrier to the vertical carrier, wherein the figure also shows a first step of the transfer from the vertical carrier to the horizontal carrier; and

FIG. 9 shows the mounting and a horizontal carrier in a lateral view, having a second exemplary embodiment of the second engagement means.

FIG. 1 by way of example shows a first potential construction of the transport system according to the invention in a plan view. Twelve horizontal stator tiles 1 are disposed in the form of a rectangle. A planar horizontal stator having a horizontal plane 2 is formed in this way. In the exemplary embodiment shown, four horizontal carriers 4 are displaceable or movable, respectively, on this horizontal plane 2, or in a floating state at a minor specific distance above this plane 2. A horizontal transport installation 6 is achieved in this way. A workpiece mounting, which in turn supports a load referred to as a payload, is able to be supported by each carrier 4; both will be shown for the first time in FIG. 4.

Furthermore according to FIG. 1, respective vertical transport installations 10 are disposed on two mutually opposite abutting edges 8 of the horizontal plane 2, the respective vertical stator tiles 12 of said transport installations 10 being shown in a schematic lateral view. These vertical stator tiles 12, in a fundamentally comparable manner, form a respective vertical stator having a respective vertical plane 14. Carriers 16 are also displaceable on the vertical planes 14, or in a floating state so as to be spaced apart from these planes 14 by a specific minor distance; said carriers 16 are thus referred to as vertical carrier 16.

FIG. 2 by way of example shows a further potential construction of a transport system according to the invention which, besides the horizontal transport installation 6 has only one vertical transport installation 10. The width of the latter is only the width of a vertical stator tile 12 and is thus minimal. Moreover, a length L of the abutting edge 8 corresponds to only the width of a vertical carrier 16 and is thus likewise minimal. According to FIG. 2, a horizontal stator having tracks that branch off is formed from the horizontal stator tiles 1.

FIG. 3 by way of example shows a further potential construction of a transport system according to the invention in a lateral view. Apart from the horizontal transport installation 6, again only one vertical transport installation 10 is provided here. Two carriers 4, 16 are shown by way of example on each of the two transport installations 6, 10. The horizontal plane 2 and the vertical plane 14 intersect in the abutting edge 8.

A fork having two prongs 18, which extend in a mutually parallel manner and at the same height level parallel to the horizontal plane 2, is fastened to each vertical carrier 16. Only one schematically illustrated prong 18 of each fork can be seen in FIG. 3.

FIG. 4 shows a section of a mounting 20 having a symbolic payload 22, and of a horizontal carrier 4, said mounting 20 and said carrier 4 being able to be utilized in one of the three preceding examples of transport systems. The mounting 20 and a main body 24 of the horizontal carrier 4 are square (this cannot be seen in the lateral section shown in FIG. 4). The main body 24 of the horizontal carrier 4, on the upper side thereof in all four corner regions has conical clearances 26 which have downward-directed tips. The sectional plane through the main body 24 of the horizontal carrier 4 in FIG. 4 is placed such that two of the total of four clearances 26 can be seen.

The mounting 20 on the lower side thereof in all four corner regions has correspondingly sized conical appendages 28 which have downward-directed tips, of which only two appendages 28 can be seen in FIG. 4. The four appendages 28 form the first engagement means according to the first exemplary embodiment.

When the mounting 20, including the payload 22, is lowered from the vertical carrier 16 (cf. FIG. 3) onto the horizontal carrier 4 and deposited on the latter, according to the double arrow, the four pairs of clearances 26 and appendages 28 assume a precise (post-)positioning function.

As a result of a square arrangement of the four pairs of clearances 26 and appendages 28 it is possible for the mounting 20 to be deposited on the horizontal carrier 4 in four rotary positions about a vertical axis (not shown), according to the double arrow, and for the form-fitting engagement according to the invention to be established in all four rotary positions, by way of which form-fitting engagement a safeguard in relation to horizontal displacement and rotation of the mounting 20 in relation to the horizontal carrier 4 is provided.

Furthermore, two hooks 30, which extend outward away from the main body, are fastened to each of the four lateral peripheries of the main body of the mounting 20. Only two hooks 30 can be seen in FIG. 4. One roof-shaped receptacle portion 32 is formed on each hook 30. The eight roof-shaped receptacle portions 32 form the second engagement means according to the exemplary embodiment. Four roof-shaped receptacle portions 32 are in each case hooked onto the prongs 18 when the mounting 20 is to be supported on the vertical carrier 16 (cf. FIG. 3).

FIG. 5 shows a plan view from above onto the mounting 20 having the payload 22 from FIG. 4, and onto the vertical carrier 16 from FIG. 3. It can be seen that two hooks 30 are fastened to each of the four peripheries of the square main body of the mounting 20 such that the mounting 20, when in engagement with the vertical carrier 16, is supported on the two parallel prongs 18 by way of four hooks 30.

As a result of this design embodiment it is possible for the mounting 20 to be deposited on the vertical carrier 16 in four rotary positions about the vertical axis (not shown).

FIGS. 6 to 8 show V-shaped receptacle portions 34 of the prongs 18. More specifically, two V-shaped receptacle portions 34 are formed in each prong 18, having a spacing which corresponds to the spacing of the two hooks 30 of one lateral periphery of the mounting 20. In this way it is possible for the form-fitting engagement according to the invention between the second engagement means (roof-shaped receptacle portions 32) and the V-shaped receptacle portions 34 of the prongs 18 to be established in four rotary positions of the mounting 20 about the vertical axis, by way of which form-fitting engagement a safeguard in relation to horizontal displacement and rotation of the mounting 20 in relation to the vertical carrier 16 is provided.

FIGS. 6 to 8 show three steps of a transfer of the mounting 20 from the horizontal carrier 4 to the vertical carrier 16, in each case in a lateral view, wherein FIG. 6 shows the first step, FIG. 7 shows the second step, and FIG. 8 shows the third step.

According to FIG. 6, the vertical carrier 4 in the direction toward the abutting edge 8 is moved (to the left) to the transfer position by means of the horizontal stator tiles 1. The horizontal carrier 4 here floats above the horizontal plane 2. In particular, the hooks 30 float above the prongs 18.

According to FIG. 7, the horizontal carrier 4 having the mounting 20 has arrived at the transfer position. The vertical carrier 16 is thereafter moved upward.

According to FIG. 8, the vertical carrier 16, by means of the prongs 18 thereof, has lifted the mounting 20 from the horizontal carrier 4 and in the process released the form-fit between the first engagement means (appendages 28) and the clearances 26, while said carrier 16 has established the form-fit between the second engagement means (roof-shaped receptacle portions 32) and the V-shaped receptacle portions 34 of the prongs 18.

FIGS. 6 to 8 also show three steps of a transfer of the mounting 20 from the vertical carrier 16 to the horizontal carrier 4, wherein FIG. 8 shows the first step, FIG. 7 shows the second step, and FIG. 6 shows the third step.

FIG. 9 shows the mounting 20 and a horizontal carrier 4 having a second exemplary embodiment of the second engagement means in a lateral view. The latter are formed by steps 36. More specifically, the mounting 20 below the main body thereof on all four lateral peripheries has a respective step 36 which extends along the respective lateral periphery and of which only three steps can be seen in FIG. 9. One prong 18 is driven into, or below, respectively, two mutually opposite steps 36.

Disclosed is a transport system composed of two planar transport installations 6, 10 which are disposed so as to be mutually perpendicular. Each transport installation 6, 10 has a stator along the plane 2, 14 of which at least one carrier 4, 16 can be displaced. At least one mounting 20 here is provided for receiving a payload 22. The mounting 20, by way of the first engagement means thereof, can be brought to engage in a form-fitting manner with the horizontal carrier 4, and by way of the separate, second engagement means thereof be brought to engage in a form-fitting manner with the vertical carrier 16. The two form-fitting engagements are designed such that the mounting 20 on the respective carrier 4, 16 is supported in relation to gravity, and is secured in relation to horizontal displacement and rotation. A transfer of the mounting 20 between the two transport installations takes place only by way of the mentioned motion functions of the two affected carriers 4, 16.

### LIST OF REFERENCE SIGNS

1 Horizontal stator tile
2 Horizontal plane
4 Horizontal carrier
6 Horizontal transport installation
8 Abutting edge
10 Vertical transport installation
12 Vertical stator tile
14 Vertical plane
16 Vertical carrier
18 Prong
20 Mounting
22 Payload
24 Main body
26 Clearance
28 Appendage
30 Hook
32 Roof-shaped receptacle portion
34 V-shaped receptacle portion
36 Step
L Length of the abutting edge

1. A transport system, comprising:
a horizontal transport installation including a horizontal stator via which at least one horizontal carrier is movable in a horizontal plane, and including a vertical transport installation which has a vertical stator via of which at least one vertical carrier is movable in a vertical plane; and,
at least one mounting configured to receive a payload, wherein
the at least one mounting has a first engagement element and a separate second engagement element,
the at least one mounting is configured to engage in a first form-fitting engagement, the at least one horizontal carrier via the first engagement element such that the at least one mounting is supported in relation to gravity, and is secured in relation to horizontal displacement, and
the at least one mounting is configured to engage in a second form fitting engagement, the at least one vertical carrier via the second engagement element such that the at least one mounting is supported in relation to gravity, and is secured in relation to horizontal displacement.

2. The transport system as claimed in claim 1, wherein
the first engagement element comprises at least two clearances which are disposed on a lower side of the at least one mounting and are open toward the bottom, and the horizontal carrier on the upper side thereof has a number of upward-directed appendages corresponding to the at least two clearances, or
the first engagement element comprises at least two downward-directed appendages which are disposed on a lower side of the at least one mounting, and the horizontal carrier on the upper side thereof has a number of clearances corresponding to the at least two downward-directed appendages that are open toward the top.

3. The transport system as claimed in claim 2, wherein the at least two pairs of appendages and clearances are provided on mutually diagonally opposite corner regions of the at least one mounting and of the at least one horizontal carrier.

4. The transport system as claimed in claim 3, wherein two further pairs of appendages and clearances are provided such that one pair of appendages and clearances are in each case provided in all four corner regions of the at least one mounting and of the at least one horizontal carrier.

5. The transport system as claimed in claim 2, wherein the clearances and the appendages are conical or coniform or frustoconical.

6. The transport system as claimed in claim 1, wherein
the at least one mounting has two mutually opposite lateral peripheries on which the second engagement element is at least partially disposed or formed, and
the second engagement element is configured to be supported on two webs or prongs of the at least one vertical carrier.

7. The transport system as claimed in claim 6, wherein
the two webs or prongs are approximately mutually parallel and approximately level, and
the two lateral peripheries are approximately mutually parallel and approximately level.

8. The transport system as claimed in claim 7, wherein
the at least one mounting has two further mutually opposite, approximately parallel and approximately level lateral peripheries on which two further engagement elements are disposed or formed, and
the two further engagement elements are configured to be supported on the two webs or prongs.

9. The transport system as claimed in claim 6, wherein
each of the two webs or prongs has two U-shaped or V-shaped receptacle portions,
the second engagement element is an arcuate or roof-shaped receptacle portions, and
two arcuate or roof-shaped receptacle portions are disposed on each of the two Of lateral peripheries.

10. The transport system as claimed in claim 9, wherein the four arcuate or roof-shaped receptacle portions are formed as hooks that protrude laterally from a main body of the at least one mounting.

11. The transport system as claimed in claim 6, wherein
the second engagement means are formed by level grooves or steps which are in each case disposed below the two lateral peripheries of the mounting, and
one web or one prong is at least in portions configured to be received in each of the grooves, or one web or one prong is at least in portions configured able to be brought to bear on each of the steps.

12. The transport system as claimed in claim 1, wherein a main body of the at least one horizontal carrier and a main body of the at least one vertical carrier are identical.

13. The transport system as claimed in claim 12, wherein the main body of the at least one horizontal carrier and the main body of the at least one vertical carrier and a main body of the mounting each have a respective square base area.

14. The transport system as claimed in claim 1, wherein
the horizontal stator is formed in a modular manner from a plurality of horizontal stator tiles,
the vertical stator is formed in a modular manner from a plurality of vertical stator tiles,
the plurality of horizontal stator tiles generate a first traveling magnetic field configured to be effective beyond peripheries of the plurality of horizontal stator tiles,
the plurality of vertical stator tiles generate a second traveling magnetic field configured to be effective beyond peripheries of the plurality of vertical stator tiles,
the at least one horizontal carriers has at least one permanent magnet via which said at least one horizontal carrier is movable,
the at least one vertical carrier has at least one permanent magnet via which said at least one vertical carrier is movable, and
the plurality of horizontal stator tiles and the plurality of vertical stator tiles are identical.

15. The transport system as claimed in claim 1, further comprising:
a first sensor system configured to determine a position of the at least one horizontal carrier relative to the horizontal stator disposed on the horizontal stator; and
a second sensor system configured to determine a position of the at least one vertical carrier relative to the vertical stator disposed on the vertical stator.
